(19) United States
(12) Patent Application Publication
(10) Pub. No.: US 2009/0104990 A1
(43) Pub. Date: Apr. 23, 2009

(54) Game device

(76) Inventors: Hiroshi Tsujino, Tokyo (JP); Kunio Sasayama, Tokyo (JP); Kaoru Mizoguchi, Osaka (JP); Hiroki Horiguchi, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/230,224

(22) Filed: Aug. 26, 2008

(30) Foreign Application Priority Data
Aug. 31, 2007 (JP) 2007-227152
Aug. 26, 2008 (JP) 2007-277152

(51) Int. Cl. A63F 13/00

(52) U.S. Cl. 463/32

(57) ABSTRACT

The game device of the present invention comprises a first image processing means for generating an image captured from the view of a virtual camera which moves together with a virtual player on landforms in a game world and displaying it as a main screen, a second image processing means for generating an image on which a destination for the virtual player can be designated and displaying it as a map image, a destination designation means for designating a destination for the virtual player, route determination means for detecting the position of a destination for the virtual player designated on the map screen, determining the shortest route connecting the detection position of the destination and the present position of the virtual player, and determining a movement route for the virtual player, and a movement control means for allowing the virtual player to move to the destination along the movement route.

### TECHNICAL FIELD

The present invention relates to a game device for executing a game in which a virtual player that can move freely in a virtual game space appears, and in particular, to a game device which allows a player to freely set a route on which a virtual player automatically moves.

### BACKGROUND ART

In so-called role-playing games and adventure games, a player object corresponding to a main character displayed on a game screen is generally allowed to move in a virtual space in accordance with the various operations of an operating means by a player. The operating means operated by a player includes, in addition to conventional input devices such as arrow keys, joysticks, and trackballs, one which uses a touch panel, such as those which have been recently developed.

For example, a game device using a touch panel has been proposed, in which, in addition to common operating means such as arrow keys, a touch panel as a second operating means is provided on a display screen, thereby allowing a game to progress with the features of both operating means utilized (see, for example, Patent Document 1).

Patent Document 1 discloses a game device comprising a first display section for displaying a first game image, an operation section comprising arrow keys or the like, a second display section for displaying a second game image which is different from the first game image, a touch panel provided on the surface of the second display section, means for controlling the motion of a first object in accordance with operations instructed by the operation section, and means for controlling the motion of a second object which is different from the first object in accordance with operations of the touch panel. Patent Document 1 also discloses that, during the control of movement of a game object, in accordance with an input path along touch positions with respect to the second game image detected by the touch panel, a corresponding path with respect to the input path in a virtual game world is calculated, and the movement direction of the second game object is determined in accordance with the corresponding path.

<Patent Document 1> Japanese Patent No. 3703473

### SUMMARY OF INVENTION

### Problems to be Solved by the Invention

In the above-described conventional game device, as disclosed in paragraph [0018] of Patent Document 1 for example, out of a plurality of game objects, an object for which it is particularly necessary to be freely operationally controlled by a player (a main object) is set to be a first object which is operated by the operation section, while an object for which it is sufficient to be roughly controlled by the player (a secondary object) is set to be a second object which is operable by a touch panel, thereby allowing a game to progress with the features of both operating means utilized. It is considered that such a game device is particularly effective for a game in which a plurality of player objects operable by a player appear in a game space, as is the case for the soccer game exemplified in Patent Document 1.

However, for a game of the type which allows a game to progress by operating only one player character corresponding to a main character, it is considered that directing the motion of the same character using both operating means brings no advantage to the player, but rather produces issues with regard to using the operating means for different purposes. In addition, since the player is required to play the game while simultaneously seeing the two images displayed on a main screen and a secondary screen, it is considered that it is difficult for the player to concentrate on the game being played on the main screen.

The present invention has been developed in view of the above-described issues, and it is an object of the present invention to provide a game device which allows a player to concentrate on a game on a screen without being distracted by moving operations undertaken on player objects or the like in a virtual space.

### Means for Solving the Problems

The present invention relates to a game device for executing a game in which a virtual player that can move freely on landforms in a game world set within a three-dimensional virtual space appears. The above-described object of the present invention is achieved by providing a first image processing means for generating an image on which a destination of the virtual player in the game world can be designated and displaying it as a map image; a second image processing means for generating an image captured from the view of a virtual camera which moves together with the virtual player and displaying it as a main screen of the game; a destination designation means for designating a destination for the virtual player for the map display on the map image through an operation input by a player; a storage means for storing the coordinate information of a plurality of route points set corresponding to the game world, information on a movement route network indicating routes connecting the route points along which the virtual player can move, and the landform information of the game world; a route determination means for judging whether or not a fixed obstacle or a fixed landform which hinders movement exists on a linear route connecting the present position of the virtual player and the set destination on the basis of the landform information, and for determining the linear route to be a movement route for the virtual player when it is judged that they do not exist and for determining the shortest route to the destination determined on the basis of the coordinate information of the nearest route point of the present position of the virtual player, the coordinate information of the nearest route point of the destination, and the information of the movement route network to be a movement route for the virtual player when it is judged that they exist; and a movement control means for allowing the virtual player to move to the destination along the movement route at a predetermined movement speed set for the virtual player.

The above-described object of the present invention is achieved more effectively by determining by the route determination means a recommended route set for the movement route network to be the movement route when the input of the destination by the destination designation means is not performed within a certain period of time after the start of the game; determining by the route determination means a recommended route set for the movement route network to be the movement route when a target for the virtual player does not exist on the main screen or within a predetermined distance of the virtual player and when the input of the destination by the destination designation means is not performed within a certain period of time at the start of the game; allowing the route determination means, on the basis of the information of the present position of objects which are set as targets for the virtual player, to set the position of an object which is nearest to the present position of the virtual player selected from the objects or the position on the landforms on which the object can be displayed on the main screen to be a destination, and to set a movement route determined on the basis of the destination and the present position of the virtual player to be the recommended route; and allowing the movement control means to change the movement speed of the virtual player in accordance with the length of the movement route; respectively.

The above-described object of the present invention is achieved more effectively by allowing the movement control means to perform speed control for increasing the movement speed of the virtual player by a predetermined amount when the distance to the destination is longer than a predetermined distance; under the condition that a plurality of ground objects having different attributes are set in advance within a field within which the virtual player can move, allowing the movement control means to change the movement speed of the virtual player on the basis of speed information set for each attribute of the ground objects; and providing an imaging control means for displaying a view mark indicating the view of the virtual player on the map screen and changing the direction of the virtual camera in synchronization with a rotational operation on the view mark through an operation by the destination designation means on the map screen; respectively.

The above-described object of the present invention is achieved more effectively by providing an imaging control means which has, as the control modes of the virtual camera, a first control mode for setting the direction of the virtual camera to be the moving direction of the virtual player and a second control mode for changing the direction of the virtual camera to the direction of the object selected by the destination designation means, and changes the direction of the virtual camera in accordance with each control mode; under the condition that a moving object which transmits information therefrom is set in the game world, providing an imaging control means for automatically changing the direction of the virtual camera to the moving object on the basis of the information transmitted from the moving object when it is judged that the virtual player comes within a predetermined distance range of the moving object; allowing the route determination means to predetermine the movement route each time the destination is directed by the destination designation means and allowing the movement control means to change the present movement route to the redetermined movement route in real time in order to allow the virtual player to move continuously; allowing the monitor on which the main screen is displayed and the monitor on which the map screen is displayed to be different monitors; allowing the route determination means, after the start of the game, to judge whether the map display is performed normally on the monitor on which the map screen is displayed, and when it is not performed normally, to determine a recommended route set for the movement route network to be the movement route; allowing the destination designation means to be a touch panel provided on the surface of the monitor on which the map screen is displayed; allowing the destination designation means to be an operation information input means connected to the game device main unit or an operation information input means provided in an operation section of the game device main unit; and allowing the monitor on which the main screen is displayed and the monitor on which the map screen is displayed to be the same monitor, and allowing the main screen and the map screen to be displayed on a display section of the monitor by screen splitting or screen switching; respectively.

The above-described object of the present invention is achieved by providing a first monitor having a touch panel on its surface; a second monitor which is different from the first monitor; a map image processing means for generating a map image for designating a destination for the virtual player in the game world and displaying it as a map image of the game on the first monitor; a main image processing means for generating a main image captured from the view of a virtual camera which moves together with the virtual player and displaying it as a main screen of the game on the second monitor; a storage means for storing the coordinate information of a plurality of route points set corresponding to the game world and information on a movement route network indicating routes connecting the route points along which the virtual player can move; a route determination means for detecting the position of a destination for the virtual player designated through an operation on the touch panel on the map image, determining the shortest route connecting the detection position of the destination and the present position of the virtual player on the basis of the coordinate information of the present position of the virtual player, the information on the detection position of the destination, the coordinate information of the route points, and information on the movement route network, and determining the shortest route to be a movement route for the virtual player; and a movement control means for allowing the virtual player to move to the destination along the movement route at a predetermined movement speed set for the virtual player.

The above-described object of the present invention is achieved more effectively by further providing a game, wherein the game is a dinosaur hunting game for hunting dinosaurs which lived in prehistoric times, further comprising a gun controller simulating a gun as an operating means by which a player performs a shooting operation, a detection means for detecting a shooting position of the gun controller on the main screen, a dinosaur motion control means for simulating the motion of the dinosaur as a target in the game world and displaying a dinosaur symbol indicating the present position of the dinosaur on the map screen, and an imaging control means for automatically changing the direction of the virtual camera to the direction of a dinosaur object corresponding to the dinosaur symbol selected by the operation of the destination designation means and performing control for tracking the dinosaur object in order to continue capturing it within the view of the virtual camera.

### EFFECTS OF THE INVENTION

According to the present invention, since the shortest route connecting the position designated on the map screen and the present position of the virtual player is determined to be a movement route for the virtual player, and the virtual player is automatically moved to a destination along the movement route at a predetermined movement speed, the player can concentrate on the game on a screen without being distracted by any movement operation undertaken on a player object or the like in the virtual space. In addition, since the shortest route is generated as a movement route, the virtual player can be moved to a destination without moving along superfluous routes.

### BRIEF DESCRIPTION OF DRAWINGS

FIG. 1 is a perspective view showing one example of the external configuration of a game device in accordance with the present invention.

FIG. 2 is a block diagram showing an internal configuration example of the game device shown in FIG. 1.

FIG. 3 is a block diagram showing a configuration example of the main part of a game control means in accordance with the present invention.

FIG. 4 is a view showing an example of a main screen displayed on the second monitor in accordance with the present invention.

FIG. 5 is a view showing an example of a secondary screen displayed on the first monitor in accordance with the present invention.

FIG. 6 is a first schematic diagram illustrating the first determination form for a movement route in accordance with the present invention.

FIG. 7 is a second schematic diagram illustrating the first determination form for a movement route in accordance with the present invention.

FIG. 8A and FIG. 8B are schematic diagrams illustrating the second determination form for a movement route in accordance with the present invention.

FIG. 9A and FIG. 9B are schematic diagrams illustrating a control example of the movement speed of the virtual player in accordance with the present invention.

FIG. 10A to FIG. 10C are schematic diagrams showing the first control example of the virtual camera in accordance with the present invention.

FIG. 11 is a schematic diagram showing the second control example of the virtual camera in accordance with the present invention.

FIG. 12 is a chart showing an example of parameters used in the control of the virtual camera in accordance with the present invention.

FIG. 13A and FIG. 13B are schematic diagrams showing a control example of the virtual camera in the first control mode in accordance with the present invention.

FIG. 14A to FIG. 14C are schematic diagrams showing control examples of the virtual camera in the second control mode in accordance with the present invention.

FIG. 15 is a schematic diagram showing the first control example of the virtual camera in the third control mode in accordance with the present invention.

FIG. 16A and FIG. 16B are schematic diagrams showing the second control examples of the virtual camera in the third control mode in accordance with the present invention.

FIG. 17 is a flowchart illustrating the movement control of the virtual player in accordance with the present invention.

FIG. 18 is a flowchart illustrating the determination processing of a movement route in accordance with the present invention.

FIG. 19A and FIG. 19B are the first schematic diagrams illustrating route searching processing in accordance with the present invention.

FIG. 20 is the second schematic diagram illustrating route searching processing in accordance with the present invention.

FIG. 21 is the third schematic diagram illustrating route searching processing in accordance with the present invention.

FIG. 22A and FIG. 22B are the fourth schematic diagrams illustrating route searching processing in accordance with the present invention.

FIG. 23 is a flowchart illustrating the control of the movement speed of the virtual player in accordance with the present invention.

FIG. 24A to FIG. 24C are schematic diagrams illustrating examples of movement control in a part other than a movement route network in accordance with the present invention.

FIG. 25 is a flowchart illustrating the control of the virtual camera in accordance with the present invention.

### DESCRIPTION OF REFERENCE NUMERALS

G1 Main screen
G2 Secondary screen
MP Map image
Ps Present position
Pe Destination (a destination point of movement)
1 Player symbol (Virtual player)
1a View mark
2 Target (Dinosaur object)
2a Dinosaur symbol
3 Movement route
4 Landform object
5 Virtual camera
6 Route image
7 Movement route network
10 Game device
11 First monitor
11a Touch panel
12 Second monitor
13 Speaker
14 Operation button
15 External storage medium
16 Gun controller
20 Control section
21 Main CPU
22 ROM
23 RAM
24 First image processing circuit
25 Second image processing circuit
26 Sound processing circuit
27 I/F circuit
30 Game processing means
31 First image processing means
32 Second image processing means
33 Route determination means
34 Movement control means
35 Imaging control means

### DESCRIPTION OF EMBODIMENTS

Hereinafter, preferred embodiments of the present invention will be described with reference to the drawings.

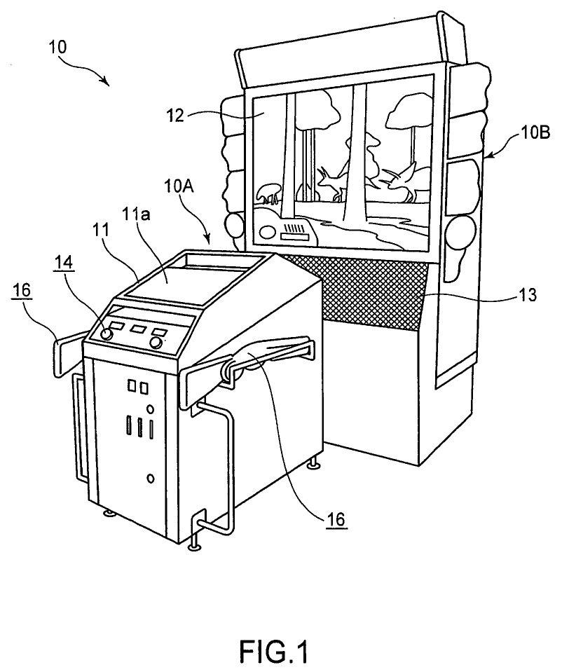

FIG. 1 is a perspective view showing an example of the external configuration of a game device to which the present invention is applied. The present invention can be applied to a portable game device provided with a touch panel or to a general game device which is not provided with a touch panel. An example of the present invention which is applied to a commercial game device 10 will be described in this instance, in which, as shown in FIG. 1, a case 10A (hereinafter referred to as the “first case”) as a game device main unit provided with a monitor 11 (hereinafter referred to as the “first monitor”) having a touch panel 11a on its surface and a case 10B (hereinafter referred to as the “second case”) provided with a monitor 12 (hereinafter referred to as the “second monitor”), which is larger when compared to the first monitor, are separated. As an example of a game provided by a computer program in accordance with the present invention, a hunting game will be described in which the shape and motion of game are simulated in a three-dimensional virtual space and are displayed on a monitor and the game are hunted by the shooting operation of a controller simulating a gun.

In FIG. 1, the first case 10A is placed at the front of the second case 10B (on the player's side). The first monitor 11 having the touch panel 11a on its surface is provided on the top face of the first case 10A. The second monitor 12 on which a main screen of a game is displayed is provided on the front upper part of the second case 10B. A speaker 13 is provided under the second monitor 12. The game device 10 of the present embodiment is a game device allowing a player to play a game while standing. The second monitor 12 on which the main screen of a game is displayed is provided at a position allowing the player to see it easily. The first monitor 11 on which the below-mentioned map image is displayed as a secondary screen is provided at a position allowing the player to operate the touch panel 11a easily. The case (the first case 10A), being the game device main unit, is provided with, in addition to the first monitor 11, an operating button (game starting button) 14, a mounting section for a controller 16, and a coin slot and coin return slot at predetermined positions. The controller 16 is, in the present embodiment, a controller (hereinafter referred to as a “gun controller”) simulating the shape and shooting mechanism of an actual gun, and allows a virtual bullet to be shot on activation of a shooting operation by the player. A shooting position on the screen is detected by a predetermined detection means.

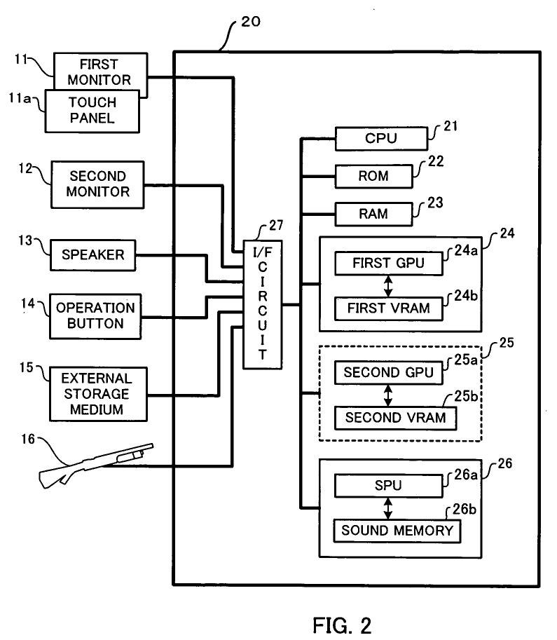

FIG. 2 is block diagram showing an example of the internal configuration example of the game device 10. A control section 20 of the game device comprises a main CPU (Central Processing Unit) 21, a ROM (Read Only Memory) 22 and a RAM (Random Access Memory) 23 as the main storage means, a first image processing circuit 24 for generating an image signal to be output to the first monitor 11 and a second image processing circuit 25 for generating an image signal to be output to the second monitor 12 on the basis of image information generated by a game program, a sound processing circuit 26 for generating a sound signal to be output to the speaker 13, and an I/F (interface) circuit 27 as an input/output control means, all of which are connected through buses.

The ROM 22 stores basic software such as a game device startup program, while the RAM temporarily stores the movement information of a mobile unit and the landform information of the virtual space obtained in accordance with the progress of the game.

The first image processing circuit 24 comprises a GPU (Graphics Processing Unit) 24a which operates in response to instructions received from the CPU 21 and a graphic memory (VRAM: Video Random Access Memory in the present embodiment) 24b, and on the basis of image information (information on a polygon object modeled in the three-dimensional virtual space, a virtual light source, a virtual camera, or the like) generated in accordance with a game program (a program allowing the computer of the game device to function as a game control means), performs coordinated transformation processing from the three-dimensional coordinates to the two-dimensional coordinates and rendering processing (image processing by shading, texture mapping, the ray tracing method, the radiosity method, or the like), and performs processing for allowing a game screen (the secondary screen of the game in the present embodiment) to be displayed on the first monitor 11.

The second image processing circuit 25, having the same configuration as the first image processing circuit 24, comprises a GPU 25a and a VRAM 25b, and on the basis of image information generated in accordance with the game program, performs processing allowing a game screen (the main screen of the game in the present embodiment) to be displayed on the second monitor 12.

In a game device which is not provided with an auxiliary processor for three-dimensional graphics processing such as a GPU and a rendering processor, the above-mentioned coordinate transformation processing and rendering processing are performed by the game program.

The voice processing circuit 26 comprises an SPU (Sound Processing Unit) 26a and a sound memory 26b, and on the basis of sound information generated in accordance with a game program allowing the CPU to function as a sound information generation means, performs processing for generating sound data of sound effects, etc. and for outputting a sound signal.

The I/F circuit 27 for input/output equipment comprises the I/F circuits of the touch panel 11a, the first monitor 11, the second monitor 12, the speaker 13, the operating button 14 (the game starting button in the present embodiment), an external storage medium 15 (and its reader/writer), and the gun controller 16.

For example, a disc-shaped external storage medium 15 is used as an information storage medium for storing game software (game programs and control data, etc.). It should be appreciated that the storage medium is not limited to the external storage medium 15, and any computer-readable information storage media can be used. When a form in which game software is downloaded to the RAM 23 or other internal storage media within the game device main unit through a network is adopted, the external storage medium 15 and its reading device become unnecessary. When the present invention is applied to a home-use game device provided with a touch panel, a common controller is used in place of the gun controller 16.

The program for achieving the game device in accordance with the present invention is a program allowing the computer of the above-described game device to function as game control means, and consists of, for example, function-by-function subroutines.

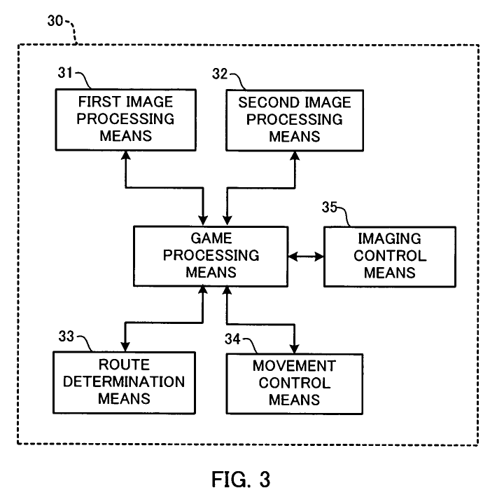

FIG. 3 is a block diagram showing a configuration example of the main part of the above-described game control means in which the elements of the game control means in accordance with the present invention are shown in connection with the function-by-function subroutines.

In FIG. 3, the game processing means 30 comprises an image processing means 31 (referred to as the “first image processing means” for the convenience of description) having the functions of generating an image of a game world captured from the view of a virtual camera which moves in the three-dimensional virtual space together with a player (a player object) in the virtual space and displaying it on the second monitor 12 through the second image processing circuit 25, an image processing means 32 (referred to as the “second image processing means” for the convenience of description) having the functions of generating an image for designating a destination of the virtual player as a secondary screen of the game and displaying it on the first monitor 11 through the first image processing circuit 24, a route determination means 33 having the function of automatically determining a movement route of the player object in accordance with an operation on the touch panel 11a as a destination designation means, a movement control means 34 having the function of allowing the player object to automatically move to a destination at a predetermined movement speed set for the player object, and an imaging control means 35 having the function of controlling the direction or the like of the virtual camera.

In the present embodiment, although an example is described in which the touch panel 11a is used as the destination designation means for designating a destination of the virtual player through an operation input by the player, any device can be used as long as a destination can be designated. For example, for a common game device which is not provided with a touch panel, as a destination designation means which is an alternative to the touch panel, operation information input means connected to the game device main unit or operation information input means provided in an operation section of the game device main unit (for example, an appropriate combination of a pointing device such as a mouse, arrow keys, a button switch, a trackball, a joystick, or the like) can be used.

In addition, in the present embodiment, the game processing means 30 comprises, as a hunting game processing means, a detection means for detecting a shooting position of the gun controller on the main screen and a dinosaur motion control means for simulating the motion of a dinosaur as a target in the game world and displaying a dinosaur symbol indicating the present position of the dinosaur on the secondary screen.

These means possessed by the game processing means 30 are classified by function with the names of the means attached, and do not limit the software configuration and hardware configuration able to be used. The below-described game processing is executed by the game processing means 30 including the above-described means.

With respect to the above-described configuration, an operation example of the game device in accordance with the present embodiment will be described.

First, in order to facilitate the reader's understanding of the present invention, a computer game in accordance with the present embodiment will be outlined.

The present invention can be preferably applied to a game device for executing a computer game of the type which allows a player to move freely in a virtual space at his/her own will, and not along predetermined routes, thereby developing a game story. Hereinafter, as a game example provided by the game device in accordance with the present invention, a game for hunting dinosaurs which lived in prehistoric times using the gun controller 16 simulating a present day gun, as shown in FIG. 1, as a weapon used by the player being a hunter (hereinafter referred to as the “dinosaur hunting game”) will be described.

In the present embodiment, an object moving in a virtual space is the object indicating the player himself/herself, and a thick forest, a river, a rock, a bridge, a mountain, or the like are set on a stage in which hunting is performed. Their shape, coloring, shade, or the like are reproduced in a three-dimensional manner by a three-dimensional model, and are displayed on the second monitor 12 of the game device 10. Hereinafter, the actual player will be referred to as the “player,” while the player in the virtual space will be referred to as the “virtual player” in order to clearly make a distinction therebetween.

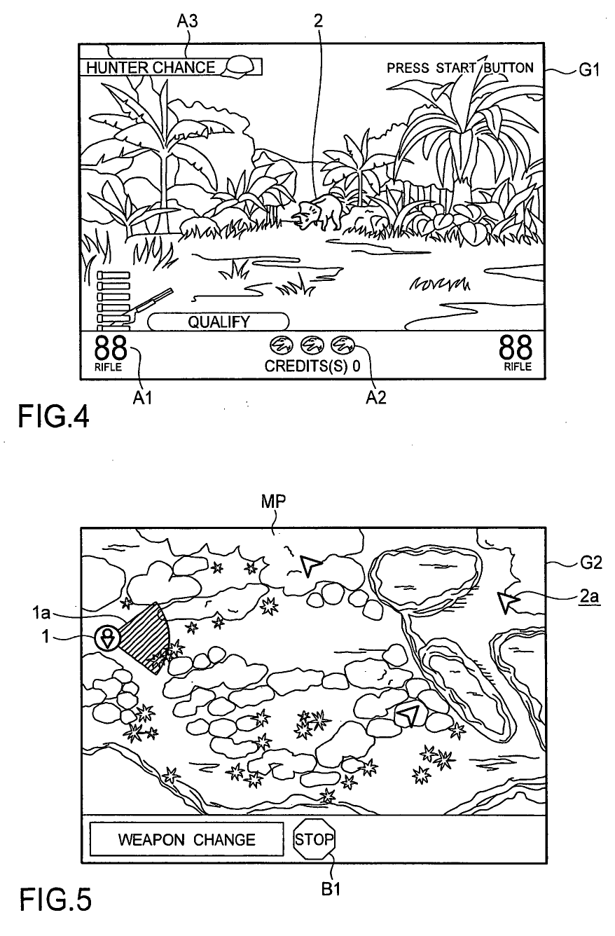

FIG. 4 shows an example of a main game screen G1 (hereinafter referred to as the “main screen”) displayed on the second monitor 12 of the game device 10, while FIG. 5 is an example of a secondary screen G2 displayed on the first monitor 11 of the game device 10. In the present embodiment, an image in the line of sight direction (normally the moving direction) of the virtual player indicating the player himself/herself is displayed on the main screen G1, while an image MP (hereinafter referred to as the “map image”) for designating a destination of the virtual player in the game world is displayed on the secondary screen G2. On this occasion, the game processing means 30 sets a virtual camera which moves together with the virtual player on the viewpoint of the virtual player or in the vicinity thereof, and while the virtual player moves, an image within the view of the virtual player in its moving direction is displayed, thereby providing the player himself/herself with a sense of actually moving. In the lower part of the main screen G1, in the present embodiment, in addition to the above-described image, information on the number of remaining bullets A1, the number of dinosaurs hunted A2 (or a bar indicating the accumulated weight of dinosaurs hunted), or the like is displayed.

The map image MP displayed on the secondary screen G2 is, in the present embodiment, an image (a reduced figure of the game world represented by three-dimensional landforms or the like) by which the whole or a wide area of the game world set in the three-dimensional virtual space can be viewed, and allows the player to view the present position of the virtual player or the position of a target within the field. In the present embodiment, as shown in FIG. 5, a player symbol 1 indicating the present position of the virtual player and a fan-shaped view mark 1a indicating the view (the line of sight direction and view angle) of the virtual player at that point are displayed, and a triangular dinosaur symbol 2a indicating the position and direction of a dinosaur object as a target is displayed. In addition, in the present embodiment, as shown in FIG. 5, a button B1 for directing, for example, to stop the virtual player while it moves is provided on the secondary screen G2.

The player symbol 1 and the dinosaur symbol 2a are not symbols of the shapes shown in FIG. 5 in the embodiments, and objects with near true representative shapes using the three-dimensional polygon models of a person (hunter) and a dinosaur are displayed. When applied to home-use game devices including a game device using an external monitor and a portable, small-sized game device, an embodiment may be employed in which the player can select a display form.

The dinosaur hunting game of the present invention will now be outlined.

Dinosaurs appearing in the virtual space are ones which are considered to have really existed in prehistoric times. The main object of the game is to kill giant dinosaurs (for example, Tyrannosauruses) set as main targets as much as possible. A number of small-sized dinosaurs (in comparison to the main targets) are arranged in the virtual space as secondary targets. These secondary targets are objects to be hunted as well. In the present embodiment, when the player performs the pumping operation of the gun controller 16, the operation is detected by the game processing section of the game device main unit, thereby simulating a gun which can shoot a plurality of (for example, five to eight) bullets successively.

A plurality of different kinds of stages for hunting in which dinosaur objects as targets are set are provided with different kinds of dinosaurs and landforms in connection with various difficulty levels. In the present embodiment, when a player plays the game for the first time, a plurality of stages with low difficulty levels are displayed as alternatives in a selectable manner and the alternatives are then changed in accordance with the evaluation result of the play at the time of completion of the various stages. For example, when a high evaluation is obtained, a difficult stage is displayed as an alternative in a selectable manner. When the rank of the virtual player corresponding to the player rises to a certain rank, the player is qualified to play the true last stage.

The stage termination condition is to kill the required number of targets set for the stage. For example, when the player fails to kill a predetermined number of targets, when the player is attacked by a dinosaur, when the game time set for the stage runs out, or when the bullets in hand run out, the game is over.

When a stage terminates, the game processing means 30 performs an evaluation of the overall hunting skill of a player with, for example, the sum total of accurate shots, the gross weight of dinosaurs killed in the stage, the number of remaining bullets, the distance when a dinosaur was hunted (the distance between the virtual player and the dinosaur), or the like set as evaluation elements, and displays the evaluation results on the screen. In the present embodiment, killed dinosaurs and their weights are displayed on the main screen G1, and information indicating the shot accuracy is displayed on the secondary screen G2 in the form of a skill table of the radar chart type. In the present embodiment, the evaluation results by item, as listed below, are displayed by a radar chart.

(1) An accuracy rate (an accuracy rate indicating the rate of the number of hits on dinosaurs in comparison to the number fired, regardless of the part of the dinosaur shot).
(2) The number of dinosaurs killed.
(3) A rank value evaluated by the length of time remaining (for example, a step corresponding to the time remaining at the moment of stage termination, when the total time set for the stage is divided into ten steps).
(4) A rank value evaluated by the distance when a hit is made on a dinosaur (for example, a step corresponding to the average value of distances added for all hits is divided into ten steps in accordance with the range (e.g., 50 meters) of a weapon).
(5) A hit number on vital spots (the total of the number of hits on vital points of a body set for each kind of dinosaur).

As game modes, a mode for one (solo hunting mode), which is a common game mode, and a game mode for two (fighting hunting mode) are provided. When playing in the two person mode, the two players play the game while viewing the same screen, each using a separate gun controller 16, and the player who kills a dinosaur first is given a score.

Next, the determination processing and movement processing of a movement route for a virtual player in a virtual space in accordance with the present invention will be described.

In the present embodiment, the game processing means 30 automatically determines a movement route (the shortest route avoiding a fixed obstacle in a preferred embodiment) to a destination directed through a touch operation on the map image by the player, and performs control for automatically moving the virtual player along the movement route, thereby allowing the player to concentrate on a hunting operation using the gun controller 16 without being distracted by any movement operation involving the virtual player.

There are two methods of determining the movement route of the virtual player. The first method is to determine the shortest route connecting an arbitrary destination directed through a touch operation on the map image by the player and the present position of the virtual player to be the movement route. The “shortest route” in this instance is a route with the shortest distance that avoids any place which hinders movement. When an obstacle exists on the way, a zigzag-line-route approximated by two or more connected lines is determined to be the route with the shortest distance. The second method is to determine the movement route along a line on the basis of detection information of a line drawn by a drag-and-drop operation on a player symbol displayed on the map image. The route determined by the second method may have an obstacle in the way. When moving the virtual player, the game processing means 30 tries to move the virtual player along the line traced by the player as far as it possibly can. When the virtual player reaches a place which hinders movement, for example, when it is determined that it has contacted the wall surface of an obstacle positioned at a certain angle or more, the movement of the virtual player is stopped there.

Hereinafter, the movement route determination processing on the basis of the above-described first and second methods will be described with reference to operation examples undertaken by a player.

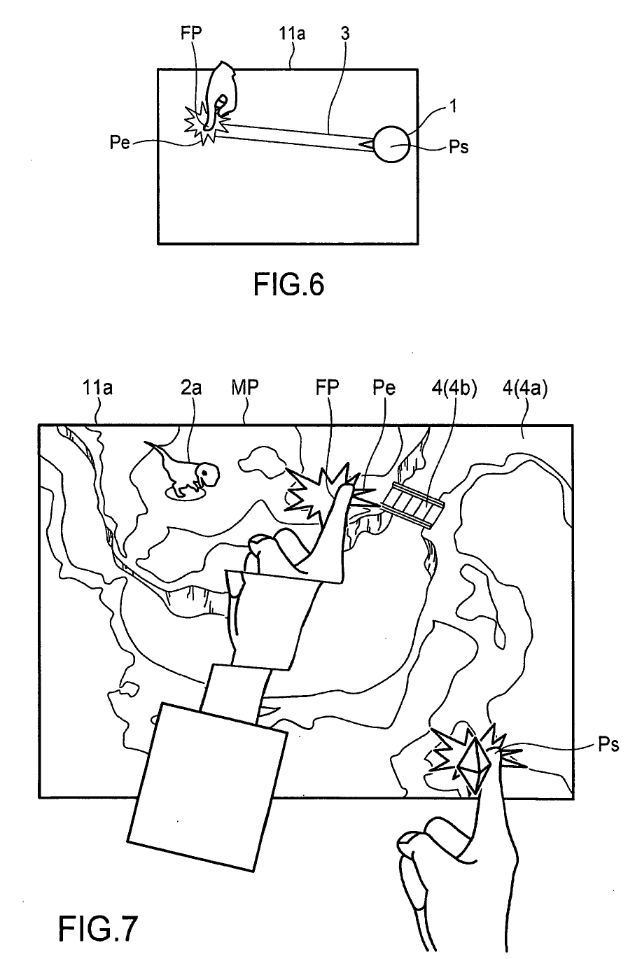

FIG. 6 is a schematic diagram showing an operation example of a touch panel in the first determination method for a movement route. On the touch panel 11a shown in FIG. 6, the map image shown in FIG. 5 is supposed to be displayed. As shown in FIG. 7, when a fingertip Fp of the player touches a desired destination Pe (a place to which the player desires to move) on the map image, a route with the shortest distance selected from among various routes in the virtual space from the preset position Ps of the player symbol to the destination Pe is automatically searched for by the game processing means 30, and the route with the shortest distance is determined to be the movement route of the virtual player 1. For example, when no area exists which hinders movement on the route to the destination Pe, a single linear route 3 is determined to be the movement route. The displacement of the picture of the human hand shown on the left side in FIG. 7 shows a situation in which the hand is moved toward the destination. The picture of the human hand shown on the right side in FIG. 7 shows the present position (movement start position) of the virtual player 1, and does not show a touch operation.

Meanwhile, when an area which hinders movement exists on the route to the destination, for example, in a stage in which a river 4a is set, as shown in FIG. 7, when a place near a dinosaur (a dinosaur symbol 2a) is touched as a destination Pe, the river 4a (water running through the bottom of a valley) which hinders movement is set as an element of a landform object 4 between the present position Ps of the virtual player and the destination Pe, making it impossible to determine a single linear route to be the movement route. In that case, a bridge 4b built over the river 4a is searched for as the shortest place to cross the river 4a, and the route with the shortest distance crossing the bridge 4b is determined to be the movement route for the virtual player 1.

Specifically, in the present embodiment, the coordinate information of a plurality of route points set corresponding to the game world and information on a movement route network indicating routes connecting the route points along which said virtual player can move are stored in storage means together with the landform information of the game world. The game processing means 30 judges whether or not a fixed obstacle or landform which hinders movement exists on a linear route connecting the present position of the virtual player and the destination designated by a touch operation, determines the linear route to be a movement route for the virtual player when judged that they do not exist, and determines the shortest route to the destination determined on the basis of the coordinate information of the nearest route point of the present position of the virtual player, the coordinate information of the nearest route point of the destination, and the information of the movement route network to be a movement route for the virtual player when it is judged that they exist.

In the present embodiment, in order for the player to recognize the movement route determined as described above, a route image (an image of the route having a certain width in the present embodiment) indicating the movement route is displayed on the map image.

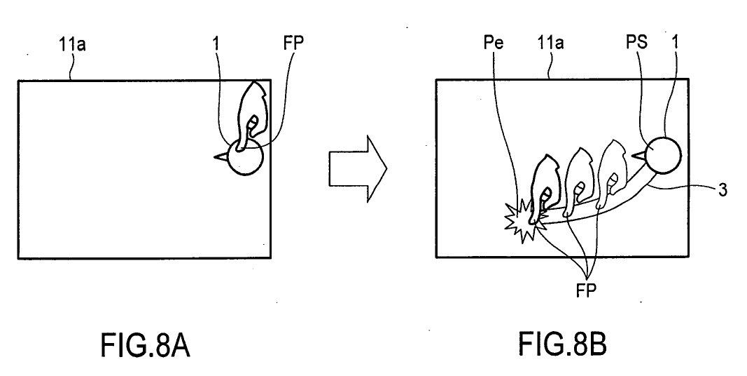

FIG. 8A and FIG. 8B are schematic diagrams showing an operation example of the touch panel for the second determination method for a movement route. With the player symbol 1 displayed on the map image touched by the fingertip Fp of the player, as shown in FIG. 8A, an operation is performed in which an arbitrary line is drawn by the fingertip Fp, and the fingertip Fp is released at a desired position (a drag-and-drop operation on the player symbol 1) as shown in FIG. 8B. Then, while the line is being drawn, a route along the line is detected and an image indicating the movement route 3 is depicted on the map image. The position at which the fingertip Fp is released is set as a destination Pe, and the route from the present position Ps of the player symbol 1 to the destination Pe is determined to be the movement route 3. Although, in the present embodiment, the line traced by the player is determined to be the movement route 3 as is, when an obstacle exists while a line is being drawn, the route may be automatically corrected so that the obstacle is avoided while still maintaining the shortest available route, and the route with the obstacle avoided then becomes the movement route 3.

Directions about the movement route using the touch panel can be performed multiple times while the player plays the game, and each time a touch operation is performed by the player, another movement route is determined.

Next, the movement control of the virtual player will be described.

The game processing means 30, on the basis of information on the movement route, corrects sharp edges of a zigzag-line-shaped route to a smooth curve, and performs control so that the virtual player moves along the corrected movement route. Since, in the present embodiment, the virtual player is not displayed on the second monitor 12, the motion of the virtual player is represented as an image from the direction of the line of sight of the virtual player captured by the virtual camera (an image appearing in the view of the virtual player). The view of the virtual player is therefore regarded to be equal to the view of the virtual camera in this instance, and control for changing the view of the virtual player will be described.

First, control for changing the movement speed of the virtual player in accordance with the distance of the movement route will be described.

In a game like a hunting game allowing free movement within a wide area in comparison to a sports game or the like, long-distance movement to a spot at which a target exists is required. In the present embodiment, although the virtual player is controlled to move automatically to a destination along a movement route in order to allow a player to concentrate on other operations, the player may feel inconvenience when the movement takes too long. In the present embodiment, the movement speed of the virtual player can be changed in accordance with the length of the movement route. For example, when the length of the movement route is shorter than a standard value (being some predetermined distance), the virtual player is moved at a predetermined speed by a walking motion, and when the length is longer than the standard value, the virtual player is moved at a predetermined speed (faster than the walking speed) by a running motion. Thus, either one of two kinds of motion, walking or running, is automatically selected in accordance with the length of the movement route, and either movement motion may be continued for as long as required.

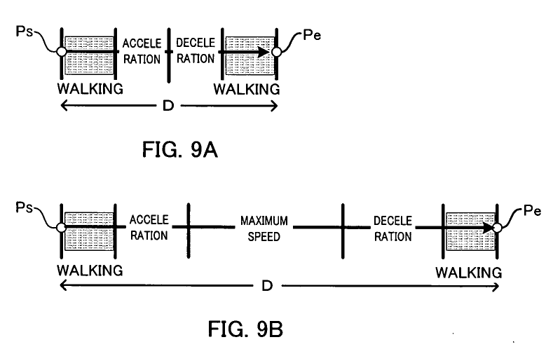

As shown in FIG. 9A and FIG. 9B, the level of movement speed may be changed in accordance with the distance to the destination (and the attribute of the ground being covered). More specifically, when the direct length from the present position Ps to the destination Pe or the length D of the movement route is longer than the standard value (being some predetermined length), the movement speed is increased by a predetermined amount. In the example shown in FIG. 9A and FIG. 9B, when the length D of the movement route is a first set value (a set value for a walking distance) or more, the virtual player is controlled to walk in the first and last parts of the movement route, and when the rest of the movement route is less than a second set value (a set value for an acceleration/deceleration distance), the virtual player is, as shown in FIG. 9A, controlled to be accelerated and then decelerated. Meanwhile, when the rest of the movement route is the second set value or more, the movement speed of the virtual player in the rest of the movement route is, as shown in FIG. 9B, changed from acceleration (for example, acceleration to running) through the maximum speed (for example, movement by running) to deceleration. The movement speed of the virtual player may be thus adjusted with a sense of “walking” to “running” to “walking” motion in accordance with the length of a line drawn on the touch panel.

In the present embodiment, when a dinosaur is captured in the view of the virtual camera while moving along the movement route, any attacking action on the dinosaur is limited and the virtual player is moved as is without changing its movement speed. The movement speed may be automatically reduced or movement may be ceased when the virtual player comes within a predetermined distance range of the dinosaur, in other words, when it is judged that the virtual player is approaching closely to the dinosaur. In addition, the movement speed of the virtual player may be changed in accordance with landform conditions. For example, the movement speed of the virtual player (which equals the movement of the virtual camera) is changed in accordance with the attributes of various kinds of ground objects (ground objects obtained through three-dimensional modeling of different kinds of landforms) constituting a landform surface which allows movement. The “ground” in this instance means a road surface on which the virtual player moves (walks or runs) using their own feet. When the virtual player moves while riding a vehicle which moves in contact with the ground, the movement of the vehicle is controlled with the vehicle regarded as being equivalent to the virtual player. The attributes of the ground include, for example, a grassy plain, a deep grassy area, a sandy place, the ground of a jungle, a stone pavement, a woody road surface (the road surface of a bridge or the like), and a metal or gravel road surface. Information indicating speed with respect to standard speed is set in connection with the attributes of the ground as speed information. The information includes, for example, “no change” for the grassy plain and the ground of a jungle, and “a little slow” for the deep grassy area. The game processing means 30 may change the movement speed of the virtual player on the basis of the speed information set by the attribute of the ground.

Next, the control of the virtual camera will be described.

The game processing means 30 performs control for moving the virtual camera in accordance with the movement of the virtual player, in which vertical fluctuations of the virtual player (viewpoint) associated with walking and running are not reproduced, and for example, the virtual camera is controlled so that it is moved smoothly at a constant height above the ground. In the cases shown below, however, vertical fluctuations of the virtual player, vertical vibrations, and a sense of looking upward, or the like are reproduced.

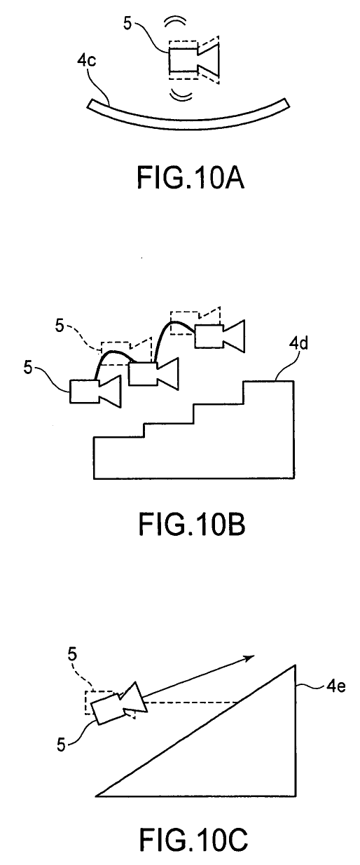

FIG. 10A to FIG. 10C are schematic diagrams showing control examples of the virtual camera 5 when the virtual player moves on special grounds. FIG. 10A shows a control example when moving on a suspension bridge 4c, FIG. 10B a stairway 4d, and FIG. 10C a slope 4e, respectively. As shown in FIG. 10A, when moving on the suspension bridge 4c, in order to reproduce a condition in which the suspension bridge 4c shakes, thereby changing the viewpoint position on a step-by-step movement, the game processing means 30 controls the virtual camera 5 so that it is vertically shaken a little in accordance with the player's movement on the suspension bridge 4c. As shown in FIG. 10B, when moving on the stairway 4d, in order to reproduce a condition in which the viewpoint position changes step-by-step on the stairway ascent (descent), the virtual camera 5 is controlled so that it hops a little. As shown in FIG. 10C, when moving on the slope 4e, in order to reproduce a feeling in which the line of sight direction turns upward a little and is not parallel to the surface of the slope, the virtual camera 5 is controlled so that it turns up (or turns down when descending the slope) a little.

Next, control for vertically changing the viewpoint position of the virtual camera in synchronization with the distance between the virtual player and a target will be described. In the present embodiment, the target is a dinosaur object, and the viewpoint position of the virtual camera is equal to the viewpoint position of the virtual player.

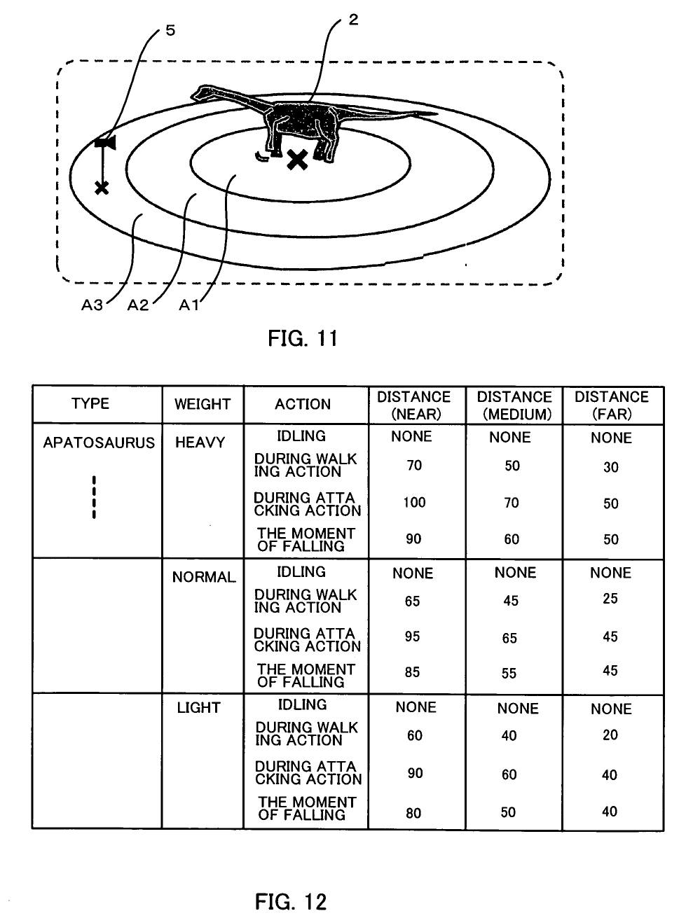

FIG. 11 shows the positional relationship between the virtual camera 5 and the dinosaur 2 in the virtual space. In the present embodiment, the distance to the dinosaur 2 is recognized by three steps (near, far, and medium therebetween). As shown in FIG. 11, in the present embodiment, three concentric circles centered on the present position of the dinosaur 2 are formed in order to determine in which of the ranges, A1, A2, or A3 shown in FIG. 11, the present position of the virtual camera 5 exists, thereby providing recognition regarding which of the ranges, A1 being near the position of the dinosaur 2, A2 being a medium distance away from the dinosaur 2, and A3 being the farthest distance away from the dinosaur 2, the virtual player is positioned in.

As shown in FIG. 12, the distance condition to the dinosaur (near, medium, and far), the action of the dinosaur 2 (while idling (being in a stationary condition), while walking, during an attacking action, and at the moment of falling), and the weight (heavy, normal, light) are set to be vibration elements (control parameters) of the ground, and the viewpoint position of the virtual camera 5 is vertically vibrated with the vibration elements reflected on the movement of the viewpoint position of the virtual camera 5. The figures shown in FIG. 12 are set values indicating the magnitude of vibration with the maximum vibration set to be 100. For example, when a heavy dinosaur falls, when the distance to the dinosaur is short, the virtual camera is vertically vibrated with a 90 percent vibration amount with respect to the maximum vibration amount, and when the distance to the dinosaur is long, the virtual camera is vertically vibrated with a 50 percent vibration amount with respect to the maximum vibration amount.

Thus in the present embodiment, an image on the main screen is vertically vibrated by changing the viewpoint position of the virtual camera for the action of the dinosaur in accordance with the distance to the dinosaur, the weight, and the type of the action at that time, and in addition, sound effects simulating, for example, the voice of the dinosaur and an earth tremor when it falls are output, thereby allowing the player to physically feel the conditions being received with both sight and sound.

Next, the control modes of the virtual camera will be described.

The control modes of the virtual camera include a first control mode for setting the moving direction of the virtual player to be the direction of the virtual camera, a second control mode for changing the direction of the virtual camera to a direction directed through a touch operation on the touch panel, and a third control mode for changing the direction of the virtual camera, in accordance with information transmitted from a dinosaur object as a target for the virtual player, to the direction of the target. The operation of the virtual camera using these control modes is controlled by the game processing means 30. Hereinafter, the control of the virtual camera in each control mode will be described with reference to various specific examples.

First, the control of the virtual camera in the first control mode will be described.

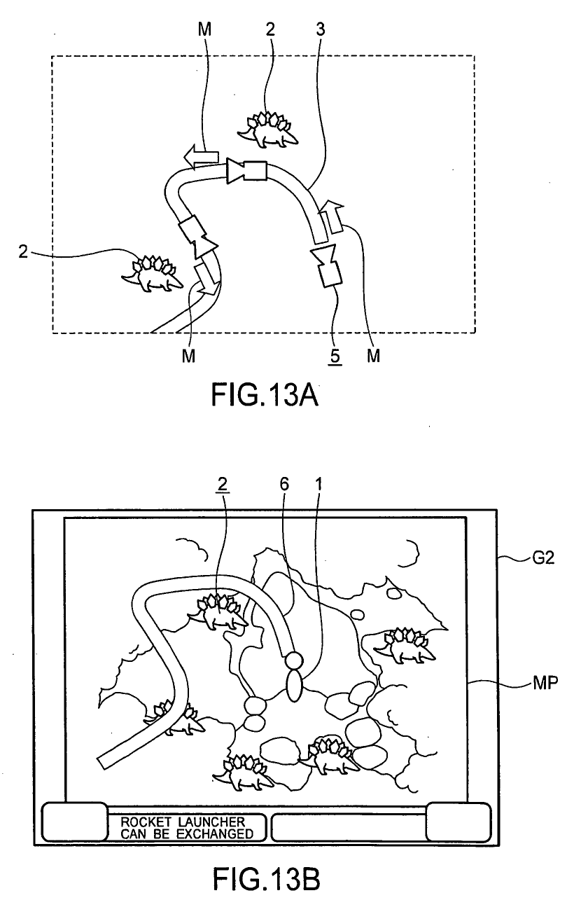

FIG. 13A is a schematic diagram showing a control example of the virtual camera in the first control mode, and FIG. 13B shows an example of a map image displayed on the secondary screen G2. For example, as shown in FIG. 13B, when the virtual player 1 is moving along a movement route (a route image 6 shown in FIG. 13B), the game processing means 30 controls the virtual camera 5 so that it is directed to the moving direction M of the virtual player 1 regardless of the presence of the dinosaur 2, as shown in FIG. 13A.

Next, the control of the virtual camera in the second control mode will be described.

In the first control mode, the direction of the virtual camera is automatically changed. Automatic focusing is prone to providing a selection that is different from that desired by the player. For example, even when a dinosaur as a target exists near the virtual player, when it is outside the view of the virtual camera, it is not displayed on the main screen, thereby making it impossible to hunt the dinosaur. In addition, when different types of dinosaurs exist around the virtual player, a situation occurs in which the virtual camera is not directed to the direction of a dinosaur that the player desires to hunt. In order to solve these problems, in the second control mode, a dinosaur to be focused on by the virtual camera can be selected by a touch operation.

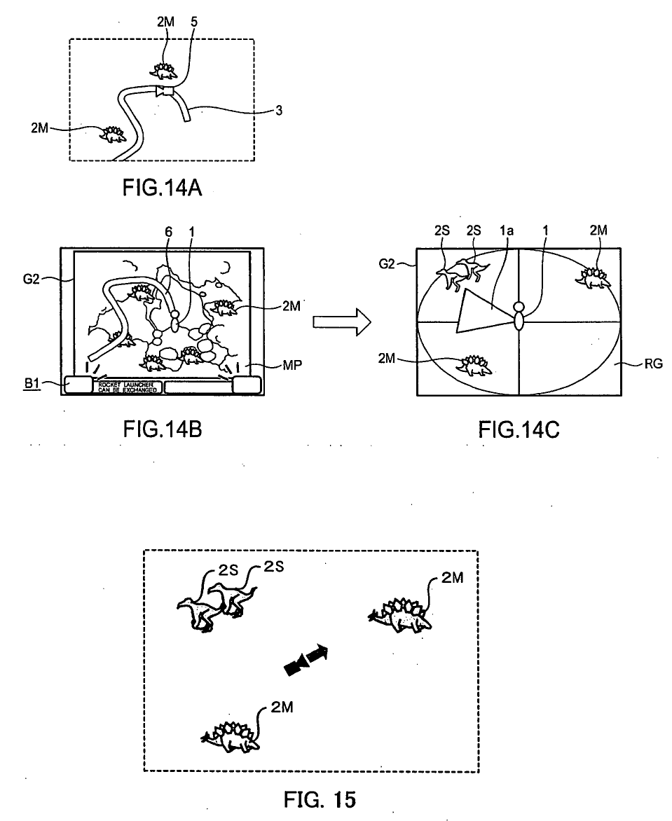

FIG. 14A to FIG. 14C are schematic diagrams showing control examples of the virtual camera in the second control mode. For example, as shown in FIG. 14A, when the virtual player (virtual camera 5), while moving along a movement route 3, approaches a main target 2M, for example, a button B1 (a button provided on the secondary screen G2) shown in FIG. 14B is lit up to notify the player of the presence of the main target 2M. The button B1 is a movement stop button for directing the suspension of movement while the virtual player is moving. The game processing means 30 accepts a touch operation on the button B1 even when the main target 2M does not exist nearby.

When a touch operation on the button B1 by the player is detected, the movement of the virtual player 1 is suspended. The map image MP displayed on the secondary screen G2 is switched to a virtual-camera-operating image RG, as shown in FIG. 14C, and the direction of the virtual camera 5 is changed to a direction directed by a touch operation on the image RG.

In the example shown in FIG. 14C, the radar-like image RG, with the surroundings of the virtual player 1 as a display area, is displayed on the secondary screen G2. Dinosaur symbols 2M and 2S existing in the vicinity of the virtual player 1 are displayed, and a dinosaur to be focused on can be selected by a touch operation. For example, in FIG. 14C, when the dinosaur symbol 2M existing at the upper right hand of the virtual player 1 is touched, the game processing means 30 changes the virtual camera to the direction of the dinosaur in the virtual space corresponding to the dinosaur symbol 2M, allowing the image within the view of the virtual camera to be displayed on the main screen.

In the present embodiment, as shown in FIG. 14C, a player symbol 1 and a view mark 1a indicating the view (the line of sight direction and view angle) of the virtual player are displayed within the image RG. In accordance with the rotation operation (hereinafter referred to as the “view angle change operation”) on the view mark 1a by the player, the view mark 1a is displayed in a rotatable manner with the present position of the virtual player on the map image as the center, and the direction of the virtual camera 5 is changed in synchronization with the view angle change operation. The view angle change operation is available even while the virtual player is moving.

Next, the control of the virtual camera in the third control mode will be described.

In the third control mode, as described above, the direction of the virtual camera is changed, in accordance with information transmitted from an object intended as a target for the virtual player, to the direction of the target. In the present embodiment, a moving object (a dinosaur object in the present embodiment) transmitting information (for example, attribute information of the object (information indicating position, type, attacking intention, or the like) or an ID specifying the object) from the object is set, and when it is judged that the virtual player comes within a predetermined distance range of the moving object, the direction of the virtual camera is automatically changed to the direction of the object on the basis of the information transmitted from the moving object.

FIG. 15 is a schematic diagram showing the first control example in the third control mode. Basically, as shown in FIG. 14A to FIG. 14C, when the virtual player approaches the main target 2M (an object having the focus right or priority of the virtual camera), the direction of the virtual camera is changed to the direction of the main target 2M.

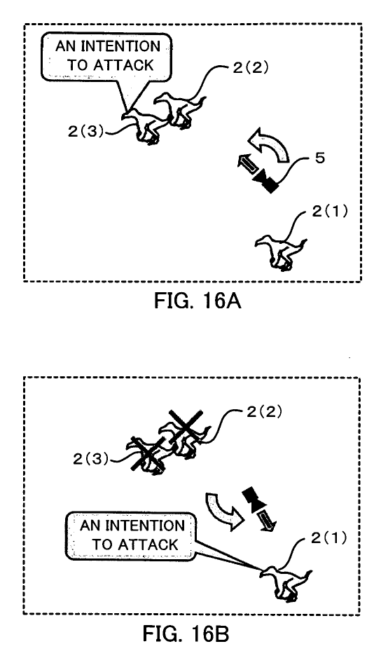

FIG. 16A and FIG. 16B are schematic diagrams showing the second control example in the third control mode. For example, as shown in FIG. 16A, when the presence of a target 2(3) is recognized on the basis of information transmitted from the target 2(3) having an attacking intention, the direction of the virtual camera 5 is changed to the direction of the dinosaur object. In addition, as shown in FIG. 16B, when a target 2(2) and a target 2(3) have fallen and another target 2(1) having an attacking intention exists, the direction of the virtual camera 5 is changed to the direction of the other dinosaur object. The second control is set to have a lower priority than the first control, and when the main target exists nearby, the first control is performed preferentially.

Next, the direction control of the virtual camera in accordance with the movement of a target will be described.

In the above-described second and third control modes, when a target existing near the virtual player is captured by the virtual camera, attention is paid to the target, and the attention is continued until the target falls or the distance between the target and the virtual player becomes a predetermined distance or more. In other words, for example, when the suspension button B1 is operated, and when a target existing near the virtual player is captured within the view of the virtual camera, when a selection operation on the target is performed, or when it is recognized that the target exists near the virtual player on the basis of the information transmitted from the target, the direction of the virtual camera is changed so that the target is tracked in order to capture it within the view of the virtual camera and it will continue tracking the target on the basis of the positional information provided regarding such. On this occasion, the horizontal direction of the virtual camera is changed with the position of the virtual camera (which equals the position of the virtual player) fixed, and the vertical direction of the virtual camera is changed within a certain range in accordance with the size of the target (for example, the height of the dinosaur). When it is judged that the target of interest has fallen, or when it is judged that the target of interest has departed to a certain distance or more, the tracking operation on the target ends. In the meantime, the view angle change operation by the player is not accepted. In order to prevent a target existing outside the view of the virtual camera (which is equal to being outside the view of the player) from attacking the virtual player, the attacking operation of the target is restricted, thereby providing a degree of control over the motion of the targets.

Next, the main processing of the game processing means in accordance with the present invention will be described with reference to a flowchart. The processing which has previously described will be omitted or simplified for this description.

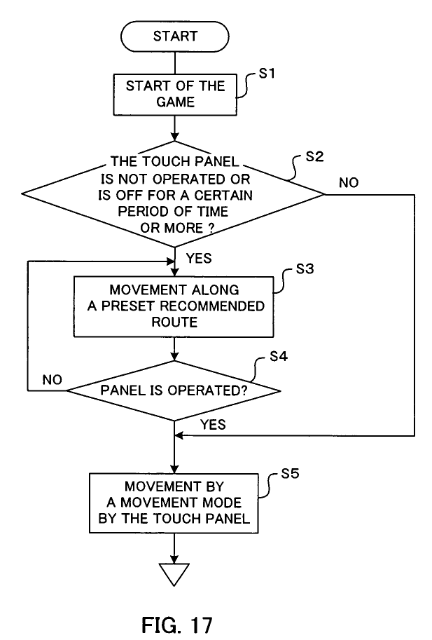

First, the movement control of the virtual player at the time of starting the game will be described with reference to the flowchart shown in FIG. 17.

When the power of the game device is turned on, and when a power-on signal is input from the first monitor provided with the touch panel, the game processing means sets, for example, a first monitor power flag, and stores the information that the power of the first monitor is turned on. When a starting operation (coin insertion in the present embodiment) by the player is then detected, the standby condition of the game device is released to start the game (Step S1). It is judged at the time of starting the game whether or not the touch panel is not operated for a certain period of time or more (whether an operation signal from the touch panel is not detected within certain period of time), and whether or not the power-on of the first monitor is not detected by the time of starting the game (the first monitor power flag is not set) (Step S2).

In the above-described Step S2, when it is judged that the touch panel is not operated for a certain period of time (for example, for 30 seconds), or when it is judged that the power of the first monitor is off, or after starting the game, when it is judged whether the map display is performed normally on the monitor on which the map screen is displayed or not, and when it is not performed, a recommended route set for the below-described movement route network in advance is determined to be the movement route. The former case may be a form in which when a game object does not exist within the main screen or within a predetermined distance range of the virtual player at the time of starting the game (for example, when a dinosaur as a target for the virtual player does not exist within a shooting range), and when the input of a destination through the touch panel is not performed within a certain period of time, the recommended route is determined to be the movement route.

On the basis of the present positional information of objects as targets for the virtual player, the position of an object which is nearest to the present position of the virtual player selected from the objects, or a position on a landform on which the virtual player can be displayed on the main screen (preferably a position within view of the virtual player and within reach of shooting) is set to be a destination, and a movement route determined on the basis of the destination and the present position of the virtual player is set (determined) to be the recommended route. On determination of the recommended route, the game processing means starts control for automatically moving the virtual player toward the destination (The destination point of movement) along the recommended route, displays an image captured from the view of the virtual camera moving together with the virtual player as the main screen on the second monitor, and displays the map image of the stage as the secondary screen on the first monitor (Step S3).

When an input is received by the touch panel, the automatic movement processing on the basis of the recommended route in the above-described Step S3 is suspended, and it is judged that the player has the ability to operate the touch panel, thereby moving on to automatic movement processing using a movement mode through the touch panel in Step S5 (Step S4).

In Step S3, rather than the method for determining a movement route allowing the virtual player to approach the object as the target, a method may be adopted for determining a movement which departs from the object as the target (for example, the dinosaur object as the main target). By performing the processing of the above-described Step S3, when a player who does not know how to operate a touch panel, or when the touch panel cannot be used owing to obstacles, the game can still be played. In addition, penalty for failure to operate the touch panel can be compensated for.

Meanwhile, in Step S2, when it is judged that the touch panel has been operated within a certain period of time, or when it is judged that the power of the second monitor is not turned off, or in Step S4, when it is judged that an operation on the touch panel has been detected, a movement route is automatically determined by the above-described first and second determination methods in accordance with an operation on the touch panel by the player, control for moving the virtual player and the virtual camera to the destination along the recommended route is undertaken, and an image captured from the view of the virtual camera is displayed as the main screen on the second monitor (Step S5).

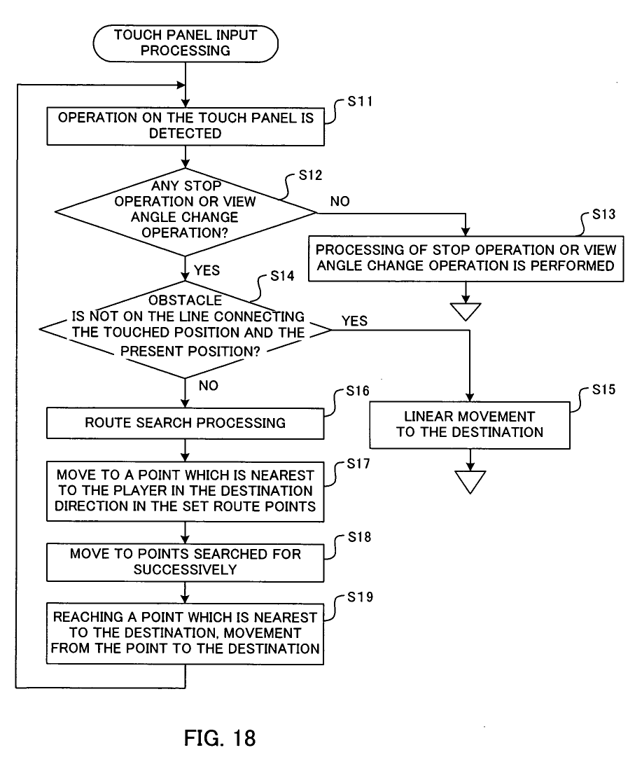

Next, the determination processing of the movement route and movement control on the movement route in the above-described Step S5 will be described in detail with reference to the flowchart shown in FIG. 18.

The game processing means, when the operation on the touch panel is detected (Step S1), judges whether the operation is the touch operation on the movement suspension button or the view angle change operation (Step S12), and when it is judged that either operation has been performed, the processing of the operation is performed. In other words, when it is judged that the touch operation on the movement suspension operation has been performed, the movement suspension processing of the virtual player is performed, and when it is judged that the rotation operation on the above-described view mark 1a has been performed, the view angle change processing of the virtual camera (which equals the virtual player) is performed (Step S13).

Meanwhile, when it is judged that neither operation has been performed in Step S12, the determination processing of the movement route is started on the basis of the detection information on an operation on the touch panel by the player. First, it is judged whether an obstacle exists or not on the line connecting the touched position and the present position with reference to landform information (landform information including the three-dimensional coordinate data of each three-dimensionally modeled landform object) corresponding to the line (line segment) connecting the touched position and the present position. The obstacle in this instance is a fixed obstacle such as a cliff, a river, a tree, a rock, or the like which hinders the movement of the virtual player (Step S14). When it is judged that an object does not exist on the line in Step S14, a linear movement route is determined on the basis of the landform information of the game world corresponding to the line connecting the detection position of the touch operation and the present position of the virtual player, and the virtual player is allowed to move to the destination using the linear movement route (Step S15).

Meanwhile, when it is judged that an obstacle exists on the line connecting the touched position and the present position in Step S14, route search processing for determining the shortest route (a movement route with the shortest distance in the present embodiment) connecting the detection position of the touch operation and the present position of the virtual player is performed, and the determined shortest route is determined to be the movement route for the virtual player (Step S16).

The route search processing in the above-described Step S16 will now be described with reference to various specific examples.

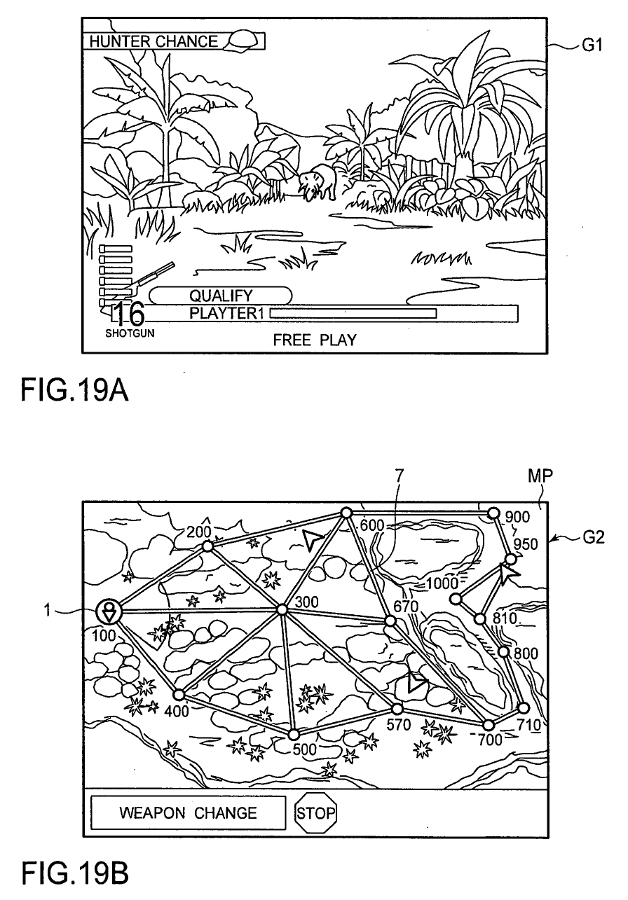

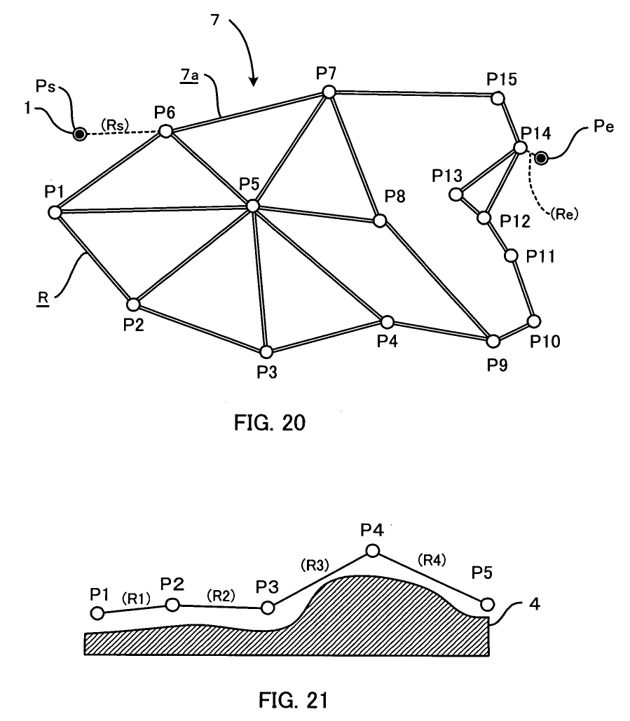

FIG. 19A and FIG. 19B show examples of the main screen G1 displayed on the second monitor and the secondary screen G2 of the stage displayed on the first monitor, respectively. In the secondary screen G2 shown in FIG. 19B, a network-like route 7 displayed on the map image MP is a route network (hereinafter referred to as the “movement route network”) formed by connecting adjacent routes which allows the virtual player to move. In the present embodiment, route points Pn (where n is an integer of two or more) for connecting a linear route or a curved route with a predetermined distance (a movement route with an arbitrary shape free from obstacles), as shown in FIG. 20, are set in advance within the game world. The movement route network 7 consists of various routes with routes which hinder movement excluded from the selectable routes connecting each route point Pn. When determining the movement route for the virtual player, the shortest route is determined on the basis of the coordinate information of each route point Pn.

For example, in FIG. 20, when searching for the shortest route connecting the present position Ps of the virtual player and the destination (the detection position of the touch operation) Pe, a route point P6 which is nearest to the present position Ps of the virtual player in the destination direction selected from the route points Pn is set to be the first via point, a route point P14 which is nearest to the destination Pe selected from the route points Pn is set to be the last via point, and the movement route network 7 is searched in order to determine the route with the shortest distance connecting the route point P6 and the route point P14. Then the route consisting of a route Rs connecting the present position Ps of the virtual player and the first via point with a line, the route with the shortest distance determined by the search processing (P6→P7→P15→P14 in this example), and a route connecting the last via point and the destination Pe is determined to be the movement route. The coordinate information of the above-described route points Pn is coordinate information providing indicators of the via points during movement. For example, as shown in FIG. 21, when the cross-sectional shape of the landform object 4 is a curve, route points P1 to P5 connecting line segments R1 to R4, as shown in FIG. 21, are set, and their three-dimensional coordinate information is stored in connection with the information on the landform object 4.

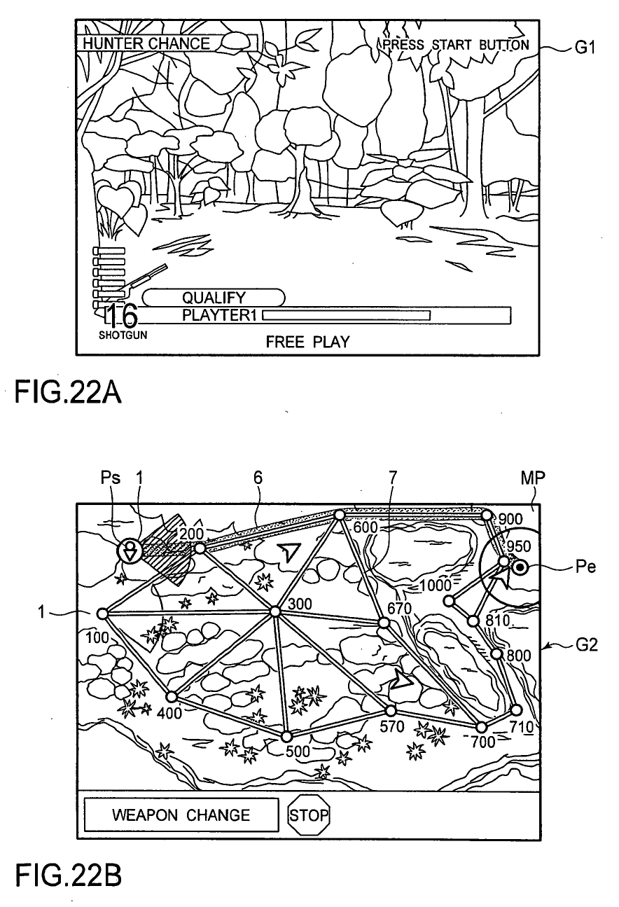

The game processing means, when the movement route is determined using the above-described movement route network in Step S16, displays a route image 6 indicating the movement route on the map image MP, as shown in FIG. 22B. The virtual player is moved to a route point which is nearest to the destination direction, and an image in the moving direction on the movement route is displayed on the main screen G1 as shown in FIG. 22A (Step S17).

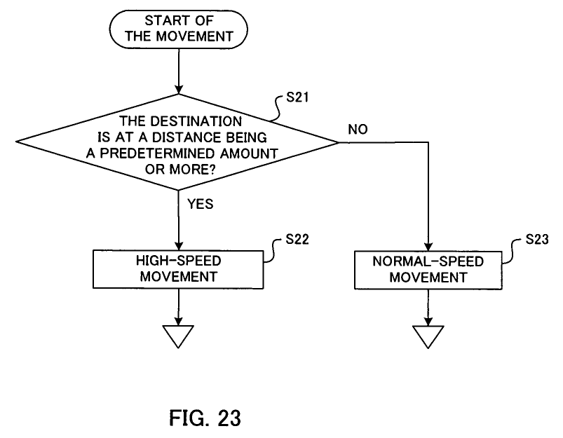

While moving on the movement route, as shown in the flowchart in FIG. 23, the virtual player is moved at high speed when the destination is at a distance being a predetermined amount or more away (Step S21, S22), and the virtual player is moved at normal speed when the destination is at a distance being less than a predetermined amount away (Step S23). After the virtual player is moved to a route point which is nearest to the present position in the destination direction in Step S17, it is successively moved to the points searched for (Step S18). When the virtual player is then moved to a route point which is nearest to the destination, the virtual player is linearly moved to the destination from the route point, and the movement of the virtual player is suspended when it reaches the destination (Step S19).

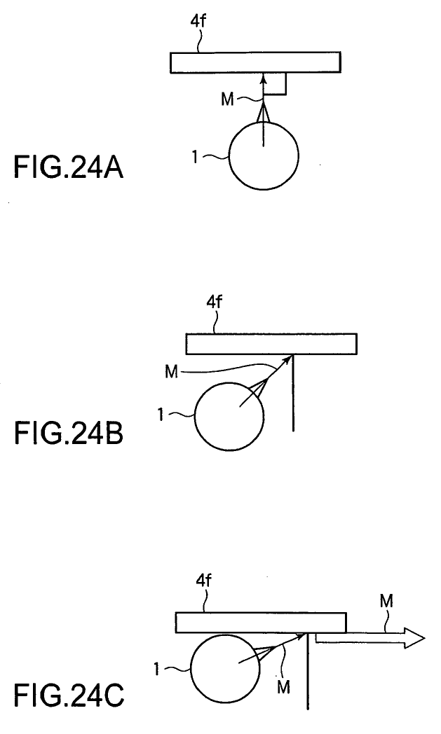

The game processing means, when an operation on the touch panel is detected while the virtual player is moving, suspends the movement action temporarily, and repeats the processing of Step S1 and later steps. In Step S17 or Step S19, as shown in FIG. 24A to FIG. 24C, when the virtual player has contacted the wall surface 4F of the obstacle positioned at a certain angle or more, the movement of the virtual player is suspended. When the angle between the wall surface 4F and the moving direction of the virtual player 1 is less than a certain angle, the virtual player 1 is moved along the wall surface 4F as shown in FIG. 24C, and when it has avoided the obstacle, it is moved to a route point linearly.

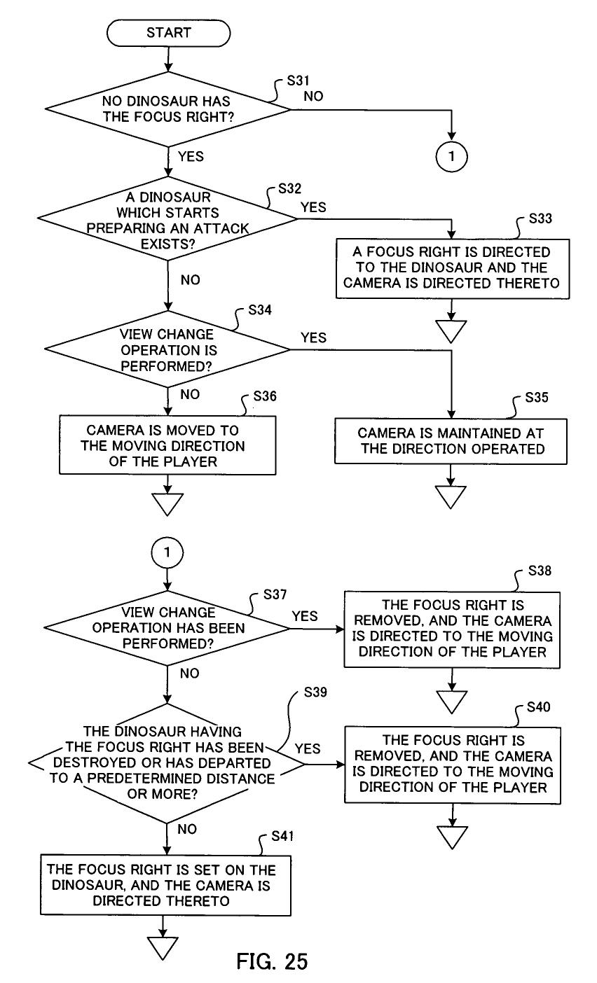

Next, the control of the virtual camera (the above-described first control mode to the third control mode) will be described with reference to the flowchart shown in FIG. 25.

The game processing means judges whether any of the dinosaurs within a predetermined range of the virtual player has the focus right or priority of the virtual camera (Step S31). When it is judged that none of the dinosaurs has the focus right, it is then judged whether a dinosaur which has started preparing an attack exists or not (Step S32), and when it is judged that a dinosaur which has started preparing an attack exists, the focus right is set on that dinosaur, and the virtual camera is directed thereto (Step S33). Meanwhile, when it is judged that a dinosaur which has started preparing an attack does not exist in Step S32, it is then judged whether a view change operation (the above-described view angle change operation) is being performed or not (Step S34), and when it is judged that the view change operation is being performed, the direction of the virtual camera is maintained at the direction in which the operation is performed (Step S35). When it is judged that the view change operation is not being performed, the virtual camera is controlled to be directed to the moving direction of the virtual player (Step S36).

Meanwhile, after the virtual camera is directed to the direction of the dinosaur in Step S33, it is then judged whether the view change operation has been performed or not (Step S37), and when it is judged that the view change operation has been performed, the focus right is removed, and the virtual camera is directed to the moving direction of the virtual player (Step S38).

Meanwhile, when the view change operation is not performed after the virtual camera is directed to the direction of the dinosaur, it is then judged whether a condition such as the dinosaur having the focus right has been destroyed or has departed to a predetermined distance or more is fulfilled or not (Step S39), and when it is judged that the condition is fulfilled, the focus right is removed, and the virtual camera is directed to the moving direction of the virtual player (Step S40). When it is judged that the condition is not fulfilled in Step S39, the focus right is set on the dinosaur, and the virtual camera is directed thereto (Step S41). By controlling the direction of the virtual camera as described, the virtual camera is prevented from being prone to be directed to a direction which is different from that desired by the player due to automatic focusing.

Although in the above-described embodiment the virtual player corresponding to the player has been described with the virtual player being the player itself, the virtual player is not limited to the player itself and may be any object, as far as the object moves in the virtual space and takes predetermined actions in accordance with the controller operations and CPU operations provided by the player.

### Other Embodiments

Although in the above-described embodiment the game device in which the first monitor on which the touch panel is provided and the second monitor are provided in different cases has been described as an example, it should be appreciated that the first monitor and the second monitor may be provided in the same case. In addition, as described above, the present invention can be applied to a portable game device provided with a touch panel or a general game device which is not provided with a touch panel.

When the present invention is applied to a general game device, for example, the above-described main screen and map screen may be displayed on the display section of the same monitor by screen splitting or screen switching. The monitor in that case may be any display device provided it can display images, such as a television, a display-only display, a projector for projecting an image onto a screen, a liquid crystal display installed in the game device main unit, or the like. As a destination designation means that is an alternative to the touch panel, as described above, an operation information input means connected to the game device main unit or operation information input means provided in an operation section of the game device main unit (an appropriate combination of a pointing device such as a mouse, arrow keys, a button switch, a trackball, a joystick, or the like) can be used. In that case, the game processing means may display a predetermined mark such as a cursor which moves in response to an operation of the operation information input means, and may process the position designated by the mark as the destination of the virtual player. When, on the basis of the detection information of a line drawn by a drag-and-drop operation on a player symbol, a route along the line is determined to be a movement route, the line drawn by the player may be detected by successively inputting operation signals from the operation information input means, or a line may be formed by detecting a plurality of points successively designated on the map screen and connecting these points.

Although in the above-described embodiments, a case in which the virtual player moves on landforms has been described as an example, the determination of a movement route and the method of movement control in accordance with the present invention are not limited to the case in which the virtual player moves on landforms, and can be applied to cases in which the virtual player moves in the sea or in outer space.

1. A game device for executing a game in which a virtual player that can freely move on landforms in a game world set in a three-dimensional virtual space appears, comprising:
a first image processing means for generating an image on which a destination of said virtual player in said game world can be designated and displaying it as a map image;
a second image processing means for generating an image captured from the view of a virtual camera which moves together with said virtual player and displaying it as a main screen of said game;
a destination designation means for designating a destination for said virtual player for the map display on said map image through an operation input by a player;
a storage means for storing the coordinate information of a plurality of route points set corresponding to said game world, information on a movement route network indicating routes connecting said route points along which said virtual player can move, and the landform information of said game world;
a route determination means for judging whether or not a fixed obstacle or a fixed landform which hinders movement exists on a linear route connecting the present position of said virtual player and said set destination on the basis of said landform information, and for determining said linear route to be a movement route for said virtual player when judged that they do not exist and for determining the shortest route to said destination determined on the basis of the coordinate information of the nearest route point of the present position of said virtual player, the coordinate information of the nearest route point of said destination, and the information of said movement route network to be a movement route for said virtual player when judged that they exist; and
a movement control means for allowing said virtual player to move to said destination along said movement route at a predetermined movement speed set for said virtual player.

2. The game device according to claim 1, wherein after the start of said game said route determination means determines a recommended route set for said movement route network to be said movement route when the input of said destination by said destination designation means is not performed within a certain period of time.

3. The game device according to claim 1, wherein at the start of said game said route determination means determines a recommended route set for said movement route network to be said movement route when a target for said virtual player does not exist on said main screen or within a predetermined distance of said virtual player and when the input of said destination by said destination designation means is not performed within a certain period of time.

4. The game device according to claim 2, wherein said route determination means, on the basis of the information of the present position of objects which are targets for said virtual player, sets the position of an object which is nearest to the present position of said virtual player selected from said objects or the position on said landforms on which said object can be displayed on said main screen to be a destination, and sets a movement route determined on the basis of said destination and the present position of said virtual player to be said recommended route.

5. The game device according to claim 1, wherein said movement control means changes the movement speed of said virtual player in accordance with the length of said movement route.

6. The game device according to claim 1, wherein said movement control means performs speed control for increasing the movement speed of said virtual player by a predetermined amount when the distance to said destination is longer than a predetermined distance.

7. The game device according to claim 1, wherein under the condition that a plurality of ground objects having different attributes are set in advance within a field within which said virtual player can move, said movement control means changes the movement speed of said virtual player on the basis of speed information set for each attribute of said ground objects.

8. The game device according to claim 1, further comprising an imaging control means for displaying a view mark indicating the view of said virtual player on said map screen and changing the direction of said virtual camera in synchronization with a rotational operation on said view mark through an operation by said destination designation means on said map screen.

9. The game device according to claim 1, further comprising an imaging control means which has, as the control modes of said virtual camera, a first control mode for setting the direction of said virtual camera to be the moving direction of said virtual player and a second control mode for changing the direction of said virtual camera to the direction of said object selected by said destination designation means, and changes the direction of said virtual camera in accordance with each control mode.

10. The game device according to claim 1, wherein a moving object which transmits information therefrom is set in said game world, comprising an imaging control means for automatically changing the direction of said virtual camera to said moving object on the basis of the information transmitted from said moving object when it is judged that said virtual player comes within a predetermined distance range of said moving object.

11. The game device according to claim 1, wherein said route determination means redetermines said movement route each time said destination is directed by said destination designation means and said movement control means changes the present movement route to said redetermined movement route in real time in order to allow said virtual player to move continuously.

12. The game device according to claim 1, wherein the monitor on which said main screen is displayed and the monitor on which said map screen is displayed are different monitors.

13. The game device according to claim 12, wherein said route determination means, after the start of the game, judges whether the map display is performed normally on the monitor on which said map screen is displayed, and when it is not performed, determines a recommended route set for said movement route network to be said movement route.

14. The game device according to claim 12, wherein said destination designation means is a touch panel provided on the surface of the monitor on which said map screen is displayed.

15. The game device according to claim 1, wherein said destination designation means is an operation information input means connected to the game device main unit or an operation information input means provided in an operation section of the game device main unit.

16. The game device according to claim 1, wherein the monitor on which said main screen is displayed and the monitor on which said map screen is displayed are the same monitor, and said main screen and said map screen are displayed on a display section of said monitor by screen splitting or screen switching.

17. The game device according to claim 1, wherein said game is a dinosaur hunting game for hunting dinosaurs which lived in prehistoric times, comprising a gun controller simulating a gun as an operating means by which a player performs a shooting operation, a detection means for detecting a shooting position of said gun controller on said main screen, a dinosaur motion control means for simulating the motion of said dinosaur as a target in said game world and displaying a dinosaur symbol indicating the present position of said dinosaur on said map screen, and an imaging control means for automatically changing the direction of said virtual camera to the direction of a dinosaur object corresponding to said dinosaur symbol selected by the operation of said destination designation means and performing control for tracking said dinosaur object to continue capturing it within the view of said virtual camera.

18. The game device for executing a game in which a virtual player which can freely move on landforms in a game world set in a three-dimensional virtual space appears, comprising:
a first monitor having a touch panel on its surface;
a second monitor different from said first monitor;
a map image processing means for generating a map image for designating a destination for said virtual player in said game world and displaying it as a map image of said game on said first monitor;
a main image processing means for generating a main image captured from the view of a virtual camera which moves together with said virtual player and displaying it as a main screen of said game on said second monitor;
a storage means for storing the coordinate information of a plurality of route points set corresponding to said game world and information on a movement route network indicating routes connecting said route points along which said virtual player can move;
a route determination means for detecting the position of a destination for said virtual player designated through an operation on said touch panel on said map image, determining the shortest route connecting the detection position of said destination and the present position of said virtual player on the basis of the coordinate information of the present position of said virtual player, the information on the detection position of said destination, the coordinate information of said route points, and information on said movement route network, and determining said shortest route to be a movement route for said virtual player;
and a movement control means for allowing said virtual player to move to said destination along said movement route at a predetermined movement speed set for said virtual player.

19. The game device according to claim 18, wherein said game is a dinosaur hunting game for hunting dinosaurs which lived in prehistoric times, further comprising a gun controller simulating a gun as an operating means by which a player performs a shooting operation, a detection means for detecting a shooting position of said gun controller on said main screen, a dinosaur motion control means for simulating the motion of said dinosaur as a target in said game world and displaying a dinosaur symbol indicating the present position of said dinosaur on said map screen, and an imaging control means for automatically changing the direction of said virtual camera to the direction of a dinosaur object corresponding to said dinosaur symbol selected by the operation of said destination designation means and performing control for tracking said dinosaur object to continue capturing it within the view of said virtual camera.
